(19) United States
(12) Patent Application Publication
(10) Pub. No.: US 2007/0117064 A1
(43) Pub. Date: May 24, 2007

(54) Dental handpiece with improved grease retention

(76) Inventors: Eugene J. Novak, Deerfield, IL (US); Mikhail Ayzenshetyn, Buffalo Grove, IL (US)

Correspondence Address: DENTSPLY INTERNATIONAL INC, 570 WEST COLLEGE AVENUE, YORK, PA, 17404, US

(21) Appl. No.: 11/654,280

(22) Filed: Jan. 17, 2007

Related U.S. Application Data
(63) Continuation-in-part of application No. 11/151,933, filed on Jun. 13, 2005, now abandoned.
Application No. 11/151,933 is a continuation of application No. 10/371,033, filed on Feb. 20, 2003, now abandoned.
(60) Provisional application No. 60/359,962, filed on Feb. 27, 2002.

(51) Int. Cl. A61C 1/05

(52) U.S. Cl. 433/132

(57) ABSTRACT

A dental handpiece has a rotor assembly (10) with a rotor (15a) and two ball bearing assemblies (13, 14) supporting a rotor (15a). At least one of the ball bearing assemblies (13, 14) has a ball (20) and a retainer (21). The retainer (21) has at least one grease retaining groove (30, 50) or void (51) therein.

### RELATED APPLICATIONS

This application is a Continuation In Part of U.S. patent application Ser. No. 11/151,933 filed Jun. 13, 2005, which is a Continuation application of U.S. patent application Ser. No. 10/371,033 (Case MID-30D) filed Feb. 20, 2003, which claims the benefit from Provisional Application No. 60/359,962 filed Feb. 27, 2002.

### TECHNICAL FIELD

The present invention is directed toward dental handpieces of the type employing greased bearings. More particularly, the invention is directed toward a dental handpiece having improved grease retention even with repeated exposure to conventional sterilization practices. The handpiece has at least one bearing retainer with a unique geometry of grease retention grooves.

### BACKGROUND OF THE INVENTION

Dental handpieces of many types, including the air-driven type are known to have an outer housing which often includes a neck portion. Within the chamber of the housing is a rotor adapted to be driven by air supplied through the handle and neck. The housing often includes upper and lower openings that are axially aligned with a rotor being supported for rotation by upper and lower bearing assemblies. The rotor often includes a bur tube that extends substantially between the openings and has a central bore axially aligned with those openings. The lower end of the bore conventionally receives a gripping chuck that is often fixed to the bur tube. Such a dental handpiece is disclosed for example, in U.S. Pat. No. 4,089,115 which is hereby incorporated by reference for such disclosure.

The bearing assemblies often include a plurality of balls held within a retainer. Foe example, U.S. Pat. No. 3,994,544 discloses such a ball and retainer bearing assembly, and is hereby incorporated by reference for such disclosure. It was a stated object of the invention of that patent to provide for a bearing for a high-speed turbine, such as may be used in a dental handpiece, and wherein the balls and retainer assembly were greased. Greasing of the bearing assemblies has proven to be a useful and desirable method of reducing friction between the balls and their supporting structure, leading to reduced wear, noise, heat build-up during use and overall improved operability of the handpieces. However, dental handpieces are unique in their use of greased bearings because of their intended use. More particularly, dental handpieces are often run at high speeds of up to 450,000 rpm or greater. Further, after each use, the handpiece must be carefully sterilized before it is used with another patient. Sterilization processes often include the use of high temperature, humidity and pressure. Such processes rapidly degrade the grease packing associated with the handpiece bearings. The grease must often be repacked repaired or otherwise compensated for, which is a time consuming and often difficult job.

A need exists therefore for a grease packed dental handpiece with improved grease retention characteristics. The handpiece should be improved with respect to the length of time and number of sterilization and use procedures that it can be subjected to before for example, repacking is necessary. The dental professional and the patient would both benefit from such a handpiece in the form of improved product quality, improved dental procedure efficiency and overall reduced dental procedure costs.

### SUMMARY OF THE INVENTION

It is therefore, an object of the invention to provide a dental handpiece.

It is another object of the invention to provide an improved grease-packed dental handpiece.

It is another object of the invention to provide a dental handpiece improved with respect to its grease retention characteristics.

These and other objects of the invention that will become apparent from the following discussion, are accomplished by the invention as hereinafter described and claimed.

These and other objects of the invention, which will become apparent from the present disclosure, are carried out by the invention as hereinafter described.

In general, a dental handpiece of the type having a rotary member supported by at least one bearing assembly, wherein said at least one bearing assembly has an annular retainer and a plurality of balls at least partially supported by said annular retainer, the improvement comprising a grease retention groove in a surface of said annular retainer.

### BRIEF DESCRIPTION OF THE DRAWINGS

FIG. 1 is a side elevational view of the rotor assembly 10, having a retainer element according to the present invention.

FIG. 2 is a perspective view of a retainer element according to the present invention.

FIG. 3 is a perspective view of an alternative embodiment of a retainer element according to the present invention.

FIG. 4 is a perspective view of an alternative embodiment of a retainer element according to the present invention.

FIG. 5 is a perspective view of an alternative embodiment of a retainer element according to the present invention.

### PREFERRED EMBODIMENTS FOR CARRYING OUT THE INVENTION

The present invention has application to any dental handpiece where it is advantageous to provide for improved grease retention properties. Such properties are especially advantageous in dental handpieces that are subjected to repeated use and sterilization under harsh conditions of high heat and moisture. The present invention may therefore, find application in any handpiece driven by electric motor, pressurized air or the like.

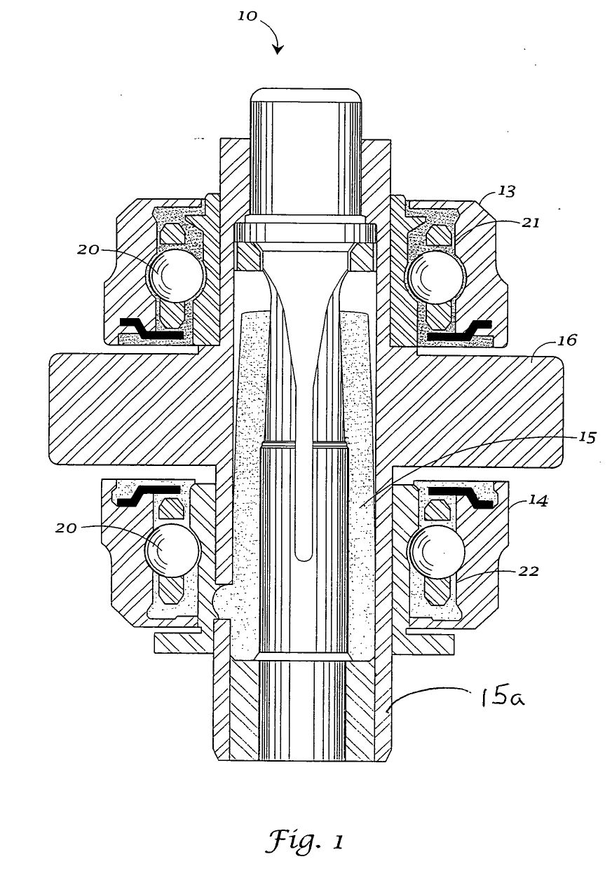

The handpiece selected for illustration is an air-driven rotor assembly 10 having a pair of ball bearing assemblies 13 and 14 supporting rotor 15a for rotation, and including a conventional chuck 15. The rotor includes any conventional driving means such as for example, an air-turbine 16 for rotatably driving rotor 15a. The turbine depicted in FIG. 1 is a radial-flow turbine that is driven by air, but of course, can be of any conventional design.

Bearing assemblies 13 and 14 are each provided with a plurality of balls 20 supported by annular retainers 21 and 22. The invention will be exemplified with reference to bearing retainer 21, it being understood that at least one and preferably both retainers 21 and 22 have the structure according to the present invention.

Dental handpiece rotor assembly 10 is of the type wherein grease (not shown) is packed into the head, such that the balls are physically coated or contacted by the grease during use. As turbine 16 causes rotor 15a to rotate, rotor 15a is supported by bearing assemblies 13 and 14. Hence, balls 20 support rotation of rotor 15a. In other words, rotor 15a is journaled within bearing assemblies 13 and 14. As is conventional, balls 20 are rollingly supported by retainer 21 within ball apertures 23 which prevents adjacent balls 20 from touching each other. The presence of grease helps to reduce the friction encountered between the contacting parts. According to the present invention, retainer 21 has structure to facilitate the physical retention of grease in proximity to such contacting parts, assuring its continued, affective presence even after repeated use and sterilizations, at least compared to conventional handpieces. By “at least partially supported” as used herein with respect to the balls 20 and the retainer 21 it is meant that the ball apertures 23 prevent adjacent balls 20 from physically contacting or touching each other.

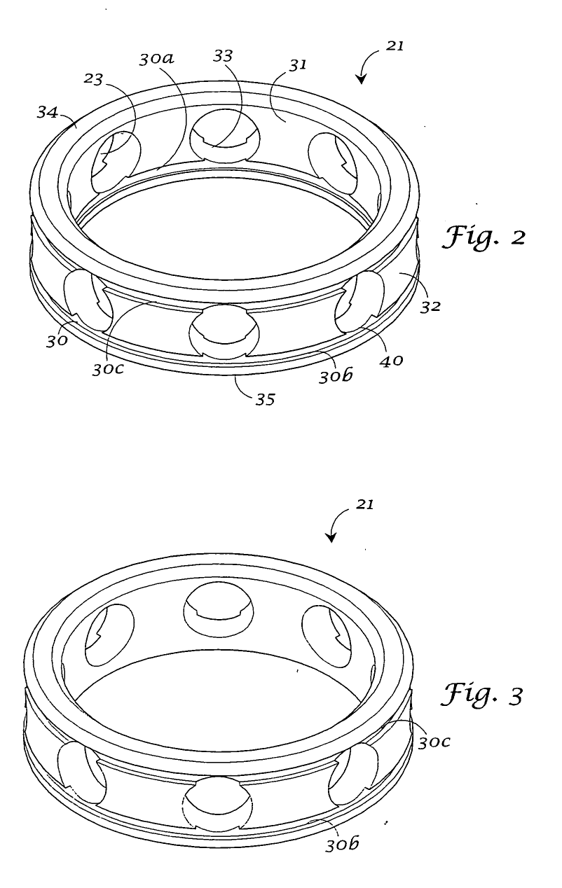

In order to facilitate such grease retention, retainer 21 is provided with at least one groove 30 in a surface thereof. By “surface” it is meant some external surface. For example, retainer 21 shown in FIG. 2 has an inner surface 31, and outer surface 32, ball retention aperture surfaces 33, upper surfaces 34 and lower surfaces 35. Further, retainer 21 shown in FIG. 2 has an inner annular groove 30a disposed on inner surface 31, a first outer annular groove 30b disposed upon outer surface 32, and a second outer annular groove 30c also disposed upon outer surface 32.

In the embodiment of the invention depicted in FIG. 2, first outer annular groove 30b and second outer annular groove 30c are spaced apart such that ball apertures 23 are positioned therebetween. Further, there is preferably an overlapping or cut-away portion of each groove 30 and a portion of each ball aperture 23, such as at overlapping portion 40. Overlapping portion 40 allows for ingress of grease held within a groove 30 into ball aperture 23 to thereby lubricate a ball 20 held therein.

It will be appreciated that any number, size, depth, location or shape of groove 30 is within the scope of the invention. Further, as will be more fully explored below, the invention can be carried out with other than a groove, such as with a hole, aperture, depression, detent, dimple, cut, void, slice or the like, and need not be annular or even regularly spaced.

For example, FIG. 3 illustrates an embodiment of the present invention having first and second outer annular grooves 30b and 30c, but no inner groove.

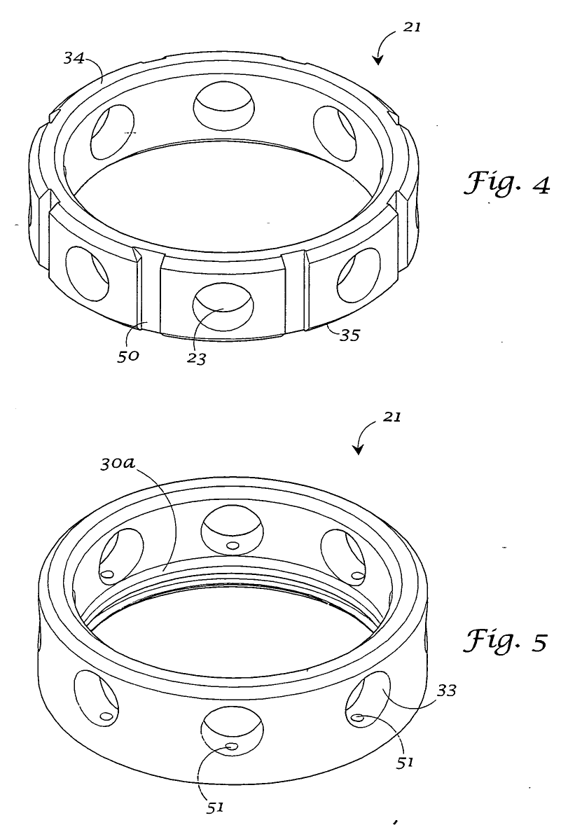

FIG. 4 illustrates an embodiment of the invention wherein a plurality of straight grooves 50 extending between upper and lower surfaces 34 and 35. In this illustration, straight grooves 50 are regularly spaced between each ball aperture 23, but need not be so. Further, grooves 50 need not be straight but may be any shape or configuration.

FIG. 5 illustrates a retainer 21 having an inner annular groove 30a, and also having a plurality of grease retaining dimples or voids 51, in this case, positioned within ball aperture surfaces 33. It will be appreciated that voids 51 can be positioned upon any external surface of retainer 21 and still be within the scope of the invention, and that any number of such voids 51 may be employed.

The size, shape, depth, spacing and location of all grooves 30, 50 or voids 51 may be varied and all fall within the scope of the invention. Each such aspect will be varied based upon the optimal end use conditions of the device with which the given retainer 21 is employed.

It has been found that the presence of grooves 30, 50 or voids such as voids 51, improve the useful life of a grease packed handpiece with which they are employed. It is believed that the grooves 30, 50 or voids 51 provide a place for excess amounts of greased to congregate or collect, beyond the amount of grease otherwise capable of being positioned proximate to the respective components. This improved collection helps to ensure a supply of grease beyond that of conventional dental handpieces. A handpiece according to the present invention thus has a longer life of use and sterilization, as compared to an otherwise similar handpiece without the inventive structure. This serves to improve the overall bearing life and hence the overall life of the handpiece, as well as ensuring that noise and friction reduction are maintained for longer periods of time than is otherwise possible.

It should be apparent therefore, that the present invention provides an advantage and an improvement over known dental handpieces. While in the foregoing, embodiments of the invention have been disclosed in considerable detail for purposes of illustration, it will be understood by those skilled in the art that many of these details may be varied without departing from the spirit and scope of the invention.

What is claimed is:

1. A dental handpiece of the type having a rotary member supported by at least one bearing assembly, wherein said at least one bearing assembly has an annular retainer and a plurality of balls at least partially supported by said annular retainer, the improvement comprising a grease retention groove in a surface of said annular retainer.
